(19) United States
(12) Patent Application Publication
(10) Pub. No.: US 2026/0080395 A1
(43) Pub. Date: Mar. 19, 2026

(54) PAYMENT TERMINAL AND PAYMENT ASSISTANCE METHOD

(71) Applicant: PANASONIC INTELLECTUAL PROPERTY MANAGEMENT CO., LTD., Osaka (JP)

(72) Inventors: Yusaku SHODA, Kanagawa (JP); Shuto UWAI, Kanagawa (JP); Katsuhiro SASAKI, Tokyo (JP)

(73) Assignee: PANASONIC INTELLECTUAL PROPERTY MANAGEMENT CO., LTD., Osaka (JP)

(21) Appl. No.: 19/400,162

(22) Filed: Nov. 25, 2025

Related U.S. Application Data
(63) Continuation of application No. PCT/JP2024/004644, filed on Feb. 9, 2024.

(30) Foreign Application Priority Data
Jun. 5, 2023 (JP) 2023-092730

(51) Int. Cl. G06Q 20/38; G06Q 20/40; G06V 20/52; G06V 40/16; H04N 23/611; H04N 23/69

(52) U.S. Cl. CPC G06Q 20/382; G06Q 20/4012; G06V 20/52; G06V 40/161; H04N 23/611; H04N 23/69

(57) ABSTRACT

A payment terminal includes a first processor, a camera, a second processor and a touch panel. When a first payment method is designated, the first processor executes the payment process requiring the input of the personal identification number, displays the input screen of the personal identification number on the touch panel, and stops receiving the input of the personal identification number upon receiving a peeping notification. When the first payment method is designated, the second processor determines whether a first person using the payment terminal and a second person other than the first person are captured in the captured image, estimates a relative positional relation between the first and second persons, determines whether the second person is a peeper based on the relative positional relation, and executes the peeping notification to the first processor when the second person is the peeper.

### CROSS-REFERENCE TO RELATED APPLICATIONS

This is a continuation of International Application No. PCT/JP2024/004644 filed on Feb. 9, 2024, and claims priority from Japanese Patent Application No. 2023-092730 filed on Jun. 5, 2023, the entire content of which is incorporated herein by reference.

### TECHNICAL FIELD

The present disclosure relates to a payment terminal and a payment assistance method.

### BACKGROUND ART

There is a device that detects presence or absence of peeping by an imaging device according to a circumstance around a user and automatically prevents the peeping. Patent Literature 1 discloses a display image control unit that prevents an image displayed on a screen of a display device from being peeped by others and that does not unnecessarily reduce operability. The display image control unit includes: a person detection unit that processes a captured image captured by an imaging device capturing an image in front of the display device and detects a person looking at the image displayed on a screen of the display device; and an image size setting unit that sets the image displayed on the screen of the display device to a normal size when the person detecting unit detects that there is only one person looking at the image displayed on the screen of the display device, and sets the image displayed on the screen of the display device to a reduced size smaller than a normal size when the person detecting unit detects that there are a plurality of persons looking at the image displayed on the screen of the display device.

### CITATION LIST

### Patent Literature

Patent Literature 1: JP2012-27641A

### SUMMARY OF INVENTION

When the display image control unit of Patent Literature 1 is applied to a payment terminal, for example, when both a camera for code payment and a camera for peeping detection are installed in the payment terminal, it may be difficult to maintain miniaturization of the payment terminal.

The present disclosure provides a payment terminal and a payment assistance method, which can improve security while maintaining miniaturization of the payment terminal.

According to an aspect of the present disclosure, a payment terminal capable of executing payment using a code, including: a camera configured to capture an image of the code used for the payment and capture an image of a subject; and a processor configured to process a captured image captured by the camera, in which the processor determines whether a first person using the payment terminal and a second person other than the first person are captured in the captured image, estimates a relative positional relation between the first person and the second person when the second person is captured, and determines whether the second person is a peeper based on the relative positional relation.

According to an aspect of the present disclosure, a payment assistance method executed by a payment terminal capable of executing payment using a code, the payment assistance method including: a step of acquiring a captured image captured by a camera configured to capture an image of the code used for the payment and capture an image of a subject, the camera being provided in the payment terminal; a step of determining whether a first person using the payment terminal and a second person other than the first person are captured in the captured image; a step of estimating a relative positional relation between the first person and the second person when the second person is captured; and a step of determining whether the second person is a peeper based on the relative positional relation.

According to the present disclosure, it is possible to improve security while maintaining miniaturization of a payment terminal.

### BRIEF DESCRIPTION OF DRAWINGS

FIG. 1 is a schematic diagram illustrating an appearance example of a payment terminal according to an embodiment;

FIG. 2 is a block diagram illustrating an electrical configuration example of the payment terminal;

FIG. 3 is a flowchart illustrating an operation example of the payment terminal;

FIG. 4 is a flowchart illustrating an operation example of the payment terminal in code payment, which is an example of payment without a personal identification number;

FIG. 5 is a schematic diagram illustrating a state in which a code is read by a camera;

FIG. 6 is a schematic diagram illustrating an embodiment in which, in a peeping detection mode, it is determined whether a third party is a peeper based on a distance between a user and the third party;

FIG. 7 is a schematic diagram illustrating an embodiment in which, in the peeping detection mode, it is determined whether the third party is the peeper based on a ratio between a size of a face of the user and a size of a face of the third party;

FIG. 8 is a schematic diagram illustrating an embodiment in which, in the peeping detection mode, it is determined whether the third party is the peeper based on an angle formed between the user and the third party;

FIG. 9 is a schematic diagram illustrating a relation between a display and each of lines of sight of the user and the third party;

FIG. 10 is a diagram illustrating an example of an angle θ1;

FIG. 11 is a schematic diagram illustrating a region that can be peeped by the third party on the display;

FIG. 12 is a flowchart illustrating an operation example of the payment terminal executed after the peeping detection mode is activated;

FIG. 13 is a schematic diagram illustrating a display example in which the user and the third party are displayed in different display modes on the display;

FIG. 14A is a sequence diagram illustrating transmission and reception of information between members of the payment terminal (part 1);

FIG. 14B is a sequence diagram illustrating transmission and reception of information between the members of the payment terminal (part 2);

FIG. 14C is a sequence diagram illustrating transmission and reception of information between the members of the payment terminal (part 3);

FIG. 15 is a block diagram illustrating a first modification of an electrical configuration of the payment terminal; and

FIG. 16 is a block diagram illustrating a second modification of the electrical configuration of the payment terminal.

### DESCRIPTION OF EMBODIMENTS

Hereinafter, an embodiment will be described in detail with reference to the drawings as appropriate. However, unnecessarily detailed description may be omitted. For example, the detailed description of well-known matters and the redundant description of substantially the same configuration may be omitted. This is to avoid unnecessary redundancy of the following description and to facilitate understanding of those skilled in the art. It should be noted that the accompanying drawings and the following description are provided for those skilled in the art to fully understand the present disclosure, and are not intended to limit the subject matter described in the claims.

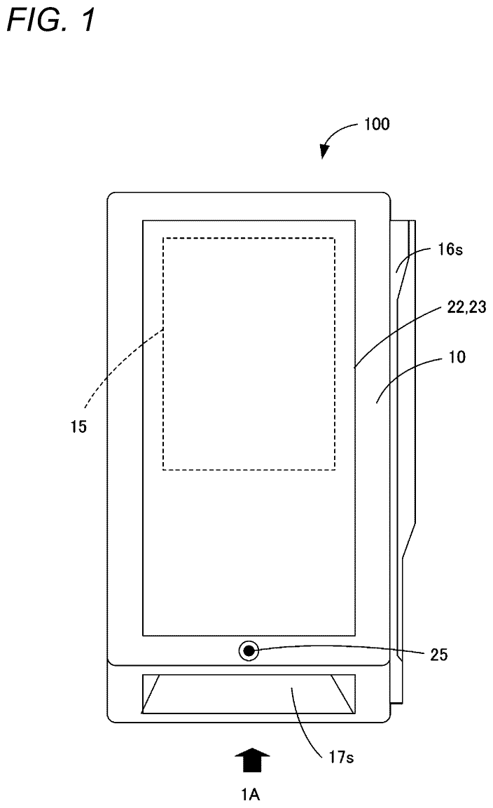

FIG. 1 is a top view illustrating an appearance example of a payment terminal 100 according to an embodiment. The payment terminal 100 includes a main body 10. The main body 10 has, for example, a generally flat plate shape. FIG. 1 illustrates a front surface 1A of the payment terminal 100. For example, a customer (user) who purchases a product operates the payment terminal 100 from a front surface 1A side. The customer may be a customer of a store. The payment terminal 100 may be a stationary terminal placed on a placement table or the like of the store, or may be a portable mobile terminal.

The payment terminal 100 includes a first card slot 16s, a second card slot 17s, a touch panel 22, a display 23, and a camera 25. The display 23 is a display device that displays an image (including, for example, a still image and a moving image). The touch panel 22 is an input unit through which the user inputs information. The touch panel 22 and the display 23 are arranged to overlap each other. As will be described later, the camera 25 can capture an image of a payment code and an image of the user and the surroundings thereof. The captured code is read.

The payment terminal 100 is a complex type that allows the customer to designate a plurality of payment methods. The plurality of payment methods include, for example, credit card payment, electronic money payment, code (for example, QR code (registered trademark)) payment, and cash payment. The credit card payment includes, for example, magnetic card payment, contact IC card payment, and non-contact IC card payment. The electronic money may include a plurality of types of electronic money. Since the electronic money payment and the non-contact IC card payment are executed using a non-contact communication (for example, a near field communication (NFC)), the electronic money payment and the non-contact IC card payment are collectively referred to as non-contact payment here.

The plurality of payment methods are executed using a plurality of corresponding payment interfaces. The plurality of payment interfaces include, for example, a credit card, an electronic money card, a code, and cash. The credit card includes, for example, a magnetic card, a contact IC card, and a non-contact IC credit card.

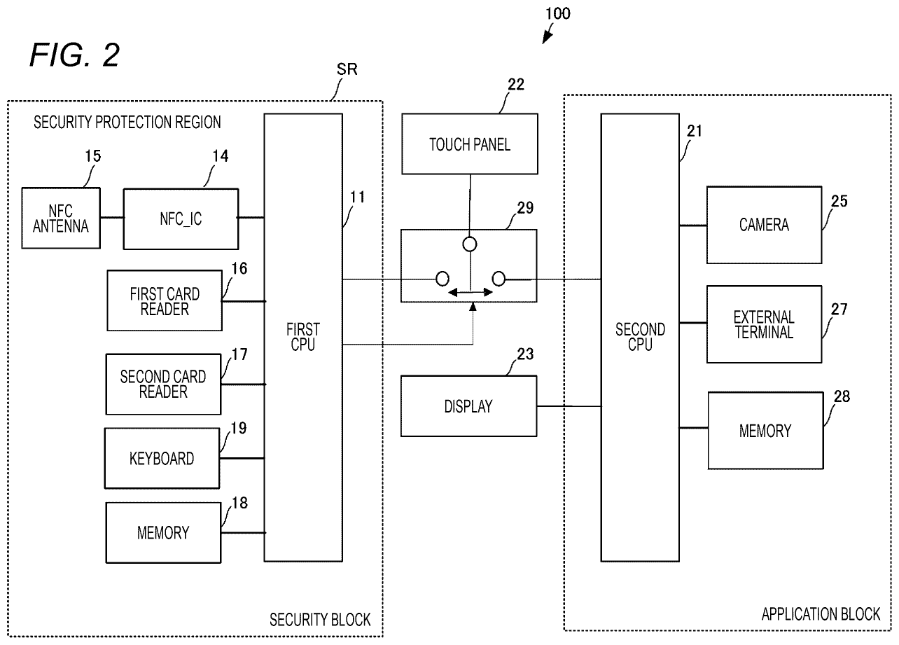

The magnetic card is inserted into the first card slot 16s and is used for payment. The contact IC card is inserted into the second card slot 17s and is used for payment. The non-contact IC credit card and the electronic money card are brought close to an NFC antenna 15 (see FIG. 2) and are used for payment. The non-contact IC credit card and the electronic money card are collectively referred to as a “non-contact IC card”.

The camera 25 is disposed in the payment terminal 100. The camera 25 may be disposed on the same plane as the touch panel 22 or the display 23, or may be disposed below the touch panel 22 or the display 23, but the disposed position is not limited thereto.

Although the touch panel 22 is illustrated as the input unit for the user, the payment terminal 100 may include other input devices such as a keyboard 19 (see FIG. 2).

Further, the payment terminal 100 includes a security protection region SR (see FIG. 2) in a part of the payment terminal 100. The security protection region SR is a region in which the security is increased compared to a region other than the security protection region SR in the payment terminal 100. For example, the security protection region SR has tamper resistance. The security of the security protection region SR may be logically increased by software processing, and the security may be physically increased by a hardware structure or mechanism. Members used for a payment process are mainly stored in the security protection region SR.

FIG. 2 is a block diagram illustrating an electrical configuration example of the payment terminal 100.

The payment terminal 100 includes the security protection region SR. The payment terminal 100 includes, inside the security protection region SR, a first central processing unit (CPU) 11, an NFC_IC 14, the NFC antenna 15, a first card reader 16, a second card reader 17, a memory 18, and a keyboard 19. The payment terminal 100 includes, outside the security protection region SR, a second CPU 21, the touch panel 22, the display 23, the camera 25, an external terminal 27, and a switch 29.

The first CPU 11 implements various functions by executing a program stored in the memory 18. The first CPU 11 collectively controls all units in the security protection region SR. The first CPU 11 executes a process related to the credit card payment and the electronic money payment, for example. The first CPU 11 functions as a payment CPU that executes a process related to payment. Further, the first CPU 11 transmits and receives data to and from the second CPU 21, and cooperates with the second CPU 21. The first CPU 11 is an example of a processor, and may be another processor.

The NFC_IC 14 executes a process for the NFC antenna 15. For example, the NFC_IC 14 controls power supply to the NFC antenna 15 and data communication via the NFC antenna 15.

The NFC antenna 15 includes, for example, a loop coil. The NFC antenna 15 receives the power supply from the NFC_IC 14 and generates a radio wave. A region within a predetermined distance from the NFC antenna 15 is a region (a non-contact communication enabled region) in which non-contact communication with the NFC antenna 15 is possible. When a non-contact IC card C3 (an example of a communication medium capable of non-contact communication) is disposed in the non-contact communication enabled area, the radio wave from the NFC antenna 15 reaches the non-contact IC card C3, and the NFC antenna 15 applies an activation power to the non-contact IC card C3. Accordingly, the NFC antenna 15 communicates data with the non-contact IC card C3.

A center position of a surface defined by the NFC antenna 15 and a center position of a surface defined by the touch panel 22 may substantially coincide with each other. In this case, by holding the non-contact IC card over the touch panel 22, the data can be communicated between the NFC antenna 15 and the non-contact IC card C3, and the user can easily understand the operation.

The NFC_IC 14 acquires (reads) information stored in the non-contact IC credit card via the NFC antenna 15. The NFC_IC 14 transmits this information to the first CPU 11 as non-contact read information. The information stored in the non-contact IC credit card and the non-contact read information include, for example, an identification number of the credit card. Further, the NFC_IC 14 acquires (reads) information stored in the electronic money card via the NFC antenna 15. The NFC_IC 14 transmits this information to the first CPU 11 as electronic money read information. The information stored in the electronic money card and the electronic money read information include, for example, an identification number of the electronic money card.

The first card reader 16 is a magnetic card reader. The first card reader 16 reads information stored in the magnetic card inserted into the first card slot 16s, and transmits the read information to the first CPU 11 as magnetic read information. The information stored in the magnetic card and the magnetic read information include, for example, an identification number of the credit card.

The second card reader 17 is a contact IC card reader. The second card reader 17 reads information stored in the contact IC card inserted into the second card slot 17s, and transmits the read information to the first CPU 11 as contact read information. The information stored in the contact IC card and the contact read information include, for example, an identification number of the credit card.

The memory 18 may include, for example, a read only memory (ROM) or a random access memory (RAM). The memory 18 stores various types of data, information, programs, and the like.

The keyboard 19 includes physical keys. The user may input various types of information (for example, a personal identification number) using the keyboard 19 instead of the touch panel 22. The payment terminal 100 may not include the keyboard 19. Input information input by an input operation to the keyboard 19 may be peeked by a third party other than the user who executes the input operation.

The second CPU 21 implements various functions by executing the program stored in the memory 28. The second CPU 21 collectively controls all units outside the security protection region SR. The second CPU 21 executes, for example, processes related to the code payment and the cash payment, and a process other than payment. Accordingly, the second CPU 21 functions as a general-purpose CPU that executes a general-purpose process. Further, the second CPU 21 transmits and receives data to and from the first CPU 11, and cooperates with the first CPU 11. The second CPU 21 is an example of a processor, and may be another processor. The second CPU 21 may have higher performance than the first CPU 11.

The second CPU 21 acquires, from the camera 25, a captured image of a subject including a code or the like displayed on a mobile terminal (not illustrated) of the customer, for example. The second CPU 21 analyzes the captured image, and recognizes identification information necessary for payment indicated by the code. The second CPU 21 executes a payment process related to code payment using this identification information.

The second CPU 21 executes various processes related to peeping detection and peeping prevention based on the captured image acquired from the camera 25. Details of the processes related to the peeping detection and the peeping prevention will be described later.

Therefore, the payment terminal 100 can use the camera 25 not only for the code payment but also for the peeping detection. Therefore, the payment terminal 100 can maintain security while implementing miniaturization of the payment terminal 100 without increasing the number of cameras 25.

The touch panel 22 has an input detection function of electrically detecting contact or proximity of a finger or the like (an example of an object) of the customer as an input (an input operation). The touch panel 22 accepts an input operation by the customer, for example. The first touch panel 22 accepts, for example, a PIN input operation, a personal identification number operation, and an electronic sign operation for the credit card payment. Input information input to the touch panel 22 by the input operation may be peeped by a third party other than the user who executes the input operation.

For example, the touch panel 22 displays a preview image based on a captured image captured by the camera 25. The customer causes a display surface (not illustrated) of the mobile terminal to face the camera 25 in order to cause the camera 25 to capture an image, and as a result, the customer can check a state of a code displayed on the mobile terminal with respect to the camera 25 by checking the display of the preview image even in a state in which it is difficult for the customer to directly view the display surface of the mobile terminal. The mobile terminal is, for example, a smartphone, a tablet terminal, or another mobile terminal, and has a display surface that displays a code CD.

The camera 25 captures an image of a subject, and acquires the captured image. The camera 25 captures an image of, for example, a code displayed on the mobile terminal of the customer, and transmits the captured image to the second CPU 21. The subject in this case is a code. The camera 25 can capture an image of the user of the payment terminal 100 and the surroundings (including a person) thereof as a subject. For example, when the camera 25 captures an image of a user or a third party other than the user at the time of payment, it is possible to determine whether peeping is occurring based on the captured image.

The external terminal 27 can be connected to various cables (for example, a local area network (LAN) cable and a universal serial bus (USB) cable). Therefore, the external terminal 27 can be connected to various external devices (for example, POS and a cash drawer) and can communicate with the external devices via various cables. Therefore, the external terminal 27 functions as a communication unit. The communication unit may execute wireless communication (for example, wireless LAN communication and Bluetooth (registered trademark) communication) without using the external terminal 27.

The memory 28 may include, for example, a ROM or a RAM. The memory 28 stores various types of data, information, programs, and the like.

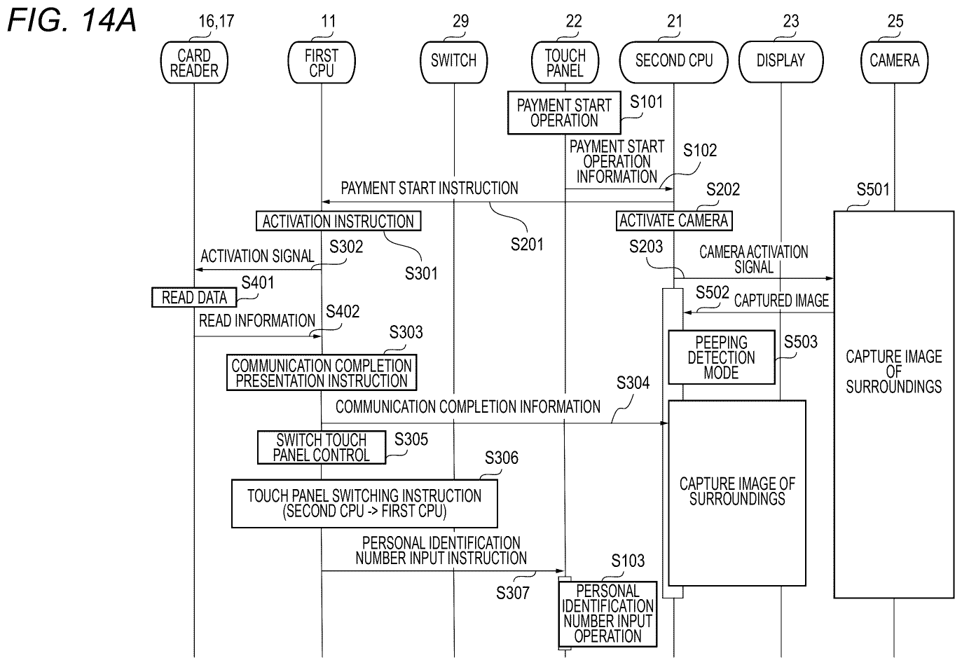

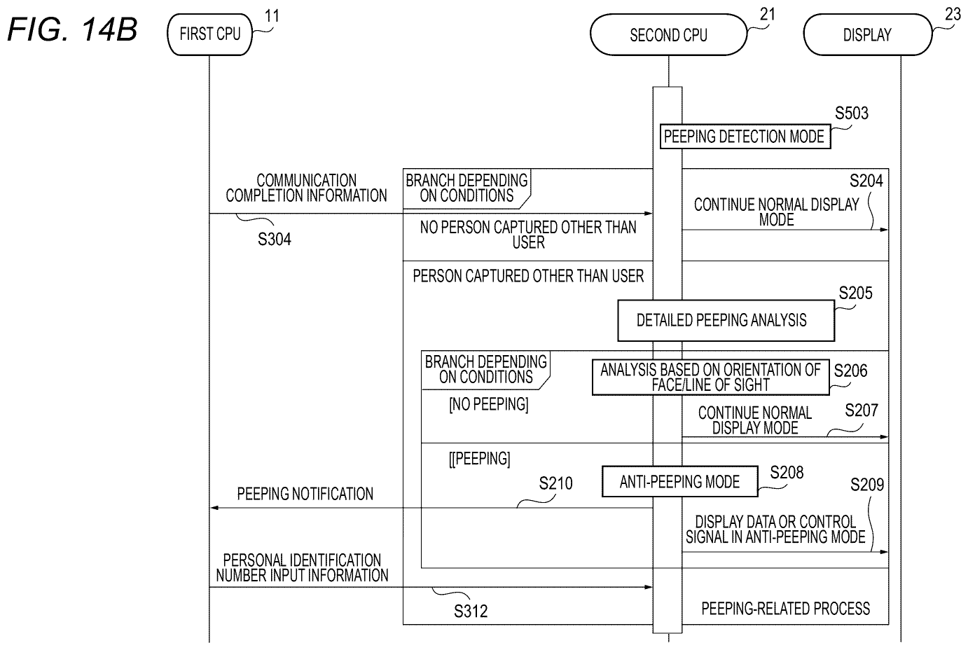

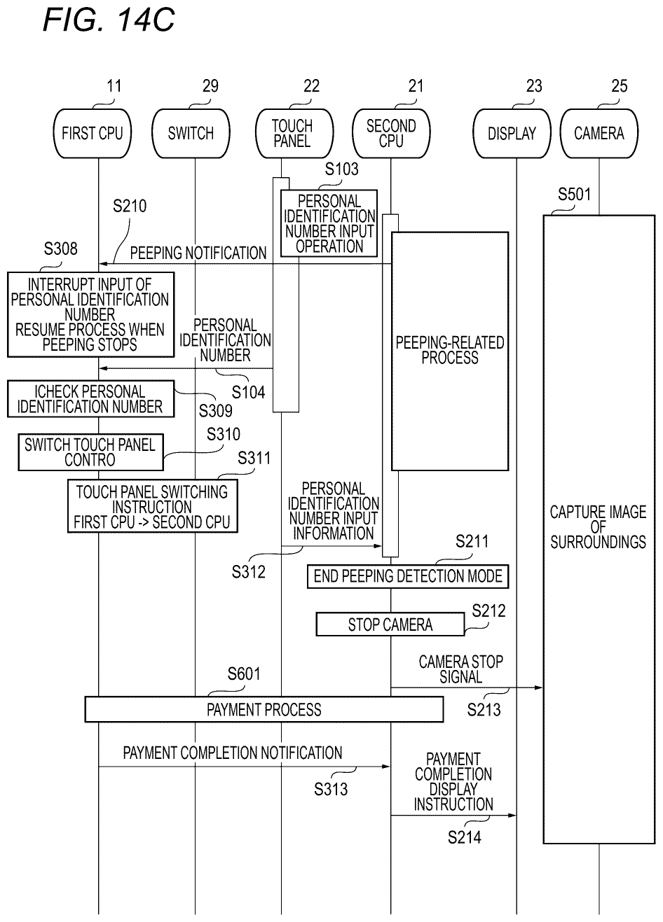

The switch 29 is connected to the first CPU 11 or the second CPU 21 based on, for example, an instruction from the first CPU 11, and executes control switching of the touch panel 22. When the switch 29 is connected to the first CPU 11, the touch panel 22 executes an input under control of the first CPU 11, and when the switch 29 is connected to the second CPU 21, the touch panel 22 executes an input under control of the second CPU 21 (see FIG. 14B). That is, the switch 29 is used when the touch panel 22 and the display 23 are shared by a payment block (security block) including components in the security protection region SR and an application block including components outside the security protection region SR. For example, the switch 29 sets a connection destination of the touch panel 22 to the second CPU 21 before the start of payment, switches the connection destination of the touch panel 22 from the second CPU 21 to the first CPU 11 at the time of a personal identification number input for the payment after the start of the payment, and switches the connection destination of the touch panel 22 to the second CPU 21 after completion of the personal identification number input for the payment.

Next, an operation example of the payment terminal 100 will be described.

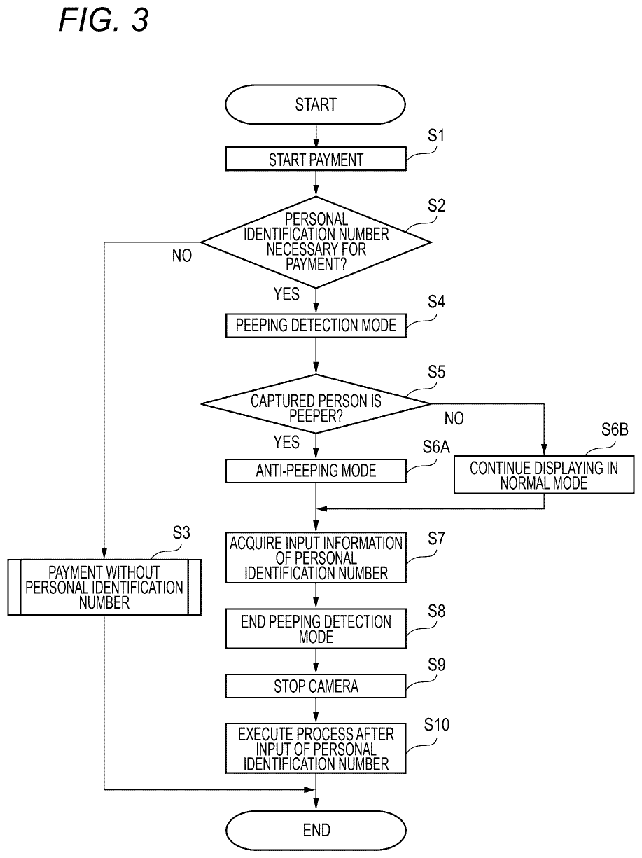

FIG. 3 is a flowchart illustrating the operation example of the payment terminal 100.

First, for example, when a store clerk operates the touch panel 22 of the payment terminal 100 to execute an input for starting payment, the second CPU 21 starts the payment (S1). In this case, for example, the second CPU 21 accepts the input operation from the store clerk via the touch panel 22, and designates one payment method from the credit card payment, the electronic money payment, the code (for example, QR code (registered trademark) payment, the cash payment, and the like.

The second CPU 21 determines whether an input of a personal identification number is necessary for the payment method (S2), executes the payment without the personal identification number (step S3) when the personal identification number is unnecessary (step S2, No), and ends the process. When the personal identification number is necessary (step S2, Yes), the process proceeds to step S4 and subsequent steps.

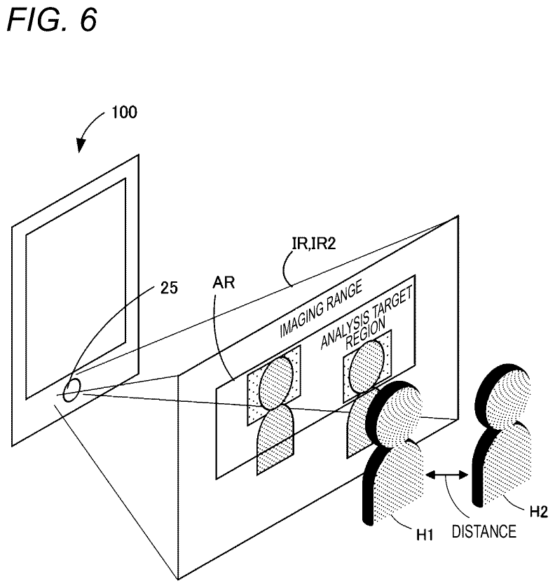

When it is necessary to input the personal identification number for the payment (step S2, Yes), a third party H2 present around a user H1 is a presence that should be guarded against. This is because the third party H2 may peep at the input of the personal identification number executed by the user H1. Therefore, the second CPU 21 activates a peeping detection mode (S4). The peeping detection mode is an operation mode in which an imaging range IR of the camera 25 is widened (for example, set to a maximum angle of view). In the peeping detection mode, the second CPU 21 widens the imaging range IR of the camera 25 compared to a case where a payment method in which an input of a personal identification number is not necessary is designated. By activating the peeping detection mode, the second CPU 21 determines whether a person (third party H2) other than the user H1 of the payment terminal 100 is captured in a captured image captured by the camera 25, and determines whether the person is a peeper who is peeping at the operation of the user H1 (S5). Detailed processing in step S4 and S5 will be described later (FIGS. 6 to 12).

If the other person is the peeper (step S5, Yes), there is a high risk that the input of the personal identification number is peeped, and thus the second CPU 21 activates an anti-peeping mode (S6A). The anti-peeping mode is an operation mode in which various processes are executed to prevent peeping. The anti-peeping mode may include notification of the peeper implemented by displaying, narrowing a viewing angle of the display 23, and the like. In this case, a viewing angle control filter may be used, or color tone contrast may be adjusted. The viewing angle control filter may be implemented by a software blind function, or a physical filter prepared in the payment terminal 100 may be inserted to turn on the filter. In addition, the second CPU 21 may execute, for example, pixel processing or color tone processing using known techniques to make the display 23 less visible when viewed obliquely.

On the other hand, if no other person is captured in the captured image or the person is not the peeper in step S5 (step S5, No), there is a low risk that the input of the personal identification number is peeped. In this case, the second CPU 21 maintains the display on the display 23 in a normal mode (S6B). That is, in this case, the second CPU 21 does not narrow the viewing angle of the display 23 as in the anti-peeping mode.

After the processing in step 6A or step S6B, when the second CPU 21 acquires input information of the personal identification number and the like input by the user H1 operating the touch panel 22 (S7), the peeping detection mode ends (S8). This is because, after the input information of the personal identification number and the like is acquired, the input of the personal identification number or the like that requires to secure the security is not executed, and the necessity of monitoring the third party H2 present around the user H1 is reduced by widening the imaging range IR. When ending the peeping detection mode, the second CPU 21 also ends the anti-peeping mode.

After the peeping detection mode ends in step S8, the second CPU 21 stops an operation of the camera 25 (S9), executes processing after the input of the personal identification number (S10), and ends the processing in FIG. 3. In the process after the input of the personal identification number, for example, a predetermined payment process is executed using the personal identification number. This payment process is executed in cooperation with, for example, a server device of an external payment center.

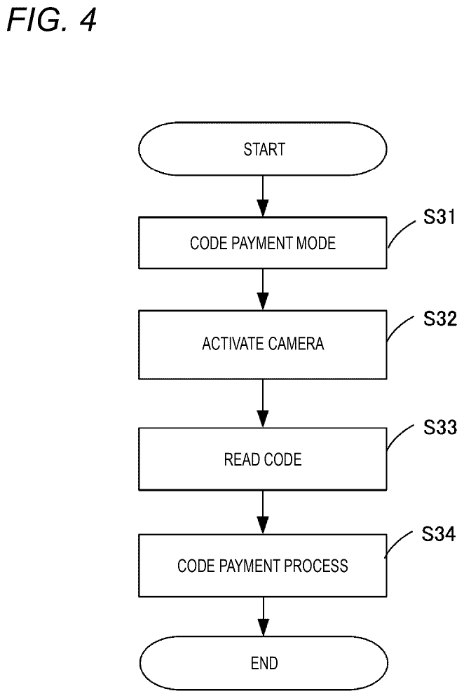

FIG. 4 is a flowchart illustrating an operation example of the payment terminal 100 in the code payment, which is an example of the payment without the personal identification number in step S3. When the payment method of the code payment is designated, the second CPU 21 activates a code payment mode as an operation mode (step S31), and activates the camera 25 (step S32). The camera 25 reads the code (step S33), and the second CPU 21 executes a code payment process (step S34).

When reading the code in the code payment mode, the second CPU 21 sets a code reading range CR that includes a range in which the code CD is present in the captured image and is narrower than the imaging range IR (image range). That is, the second CPU 21 reduces an effective pixel to be read as a code. Accordingly, the payment terminal 100 can reduce a processing load when reading the code and speed up code reading.

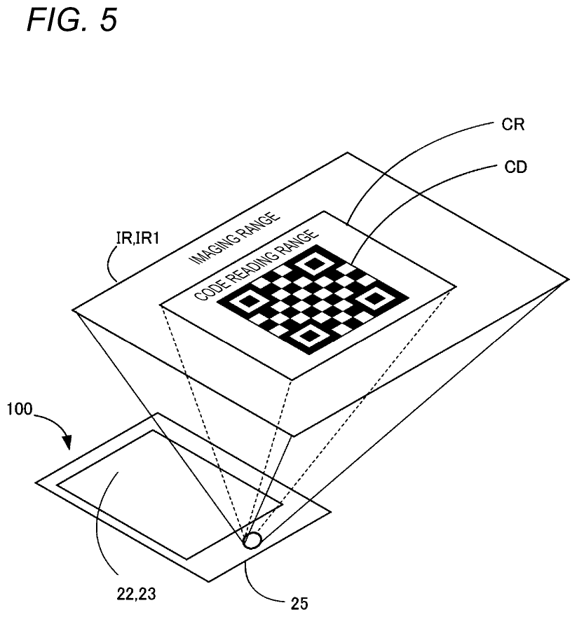

FIG. 5 is a schematic diagram illustrating a state in which the code CD is read by the camera 25.

The camera 25 can change the imaging range IR that can be captured by the camera 25. At the time of code payment in FIG. 4, the second CPU 21 sets the imaging range IR to an imaging range IR1. The second CPU 21 sets the code reading range CR of the code CD narrower than the imaging range IR1. The second CPU 21 extracts (cuts out) the code reading range CR from the imaging range IR1. That is, when reading the code CD, the second CPU 21 optimizes the imaging range IR1 using a method such as clipping or angle-of-view adjustment (narrowing the angle of view), and limits an analysis area (code reading range CR) of the code CD in the imaging range IR1. Accordingly, the payment terminal 100 can improve a processing speed of reading and analyzing the code CD. The code CD in FIG. 5 is a two-dimensional code such as the QR code (registered trademark), but may be a one-dimensional code. The actual imaging range IR of the camera 25 at the time of code payment is set to a range including the code reading range CR and included in the maximum imaging range that can be captured.

FIG. 6 is a schematic diagram illustrating an example in which in the peeping detection mode, an imaging range IR2 that can be captured by the camera 25 is illustrated, and it is determined whether the third party H2 is the peeper based on a distance between the user H1 and the third party H2. The second CPU 21 executes various processes on the captured image captured by the camera 25.

As described above, the second CPU 21 may execute payment according to a plurality of payment methods. The plurality of payment methods are broadly divided into a first payment method that uses input information (for example, a personal identification number or an electronic signature) used for authenticating the payment and a second payment method that does not use the input information. Then, when a payment method (first payment method) is designated in which payment is executed using the personal identification number, the second CPU 21 widens the imaging range IR of the camera 25 compared to when a payment method (second payment method) is designated in which the payment is executed without using the personal identification number.

Specifically, as in the code payment illustrated in FIGS. 4 and 5, in the second payment method that does not use the personal identification number, the second CPU 21 sets the imaging range IR1 as the imaging range IR. On the other hand, in the first payment method that uses the personal identification number, the second CPU 21 sets an imaging range IR2 wider than the imaging range IR1 as the imaging range IR.

Therefore, even when the payment is executed using the personal identification number or the electronic signature, the payment terminal 100 makes it easier for the peeper who may be present around the user H1 of the payment terminal 100 to be captured, thereby strengthening monitoring of the peeper and further improving reliability of the security.

When the second payment method is payment using the code CD and the second payment method is designated, the second CPU 21 sets the imaging range IR to the imaging range IR1 narrower than the imaging range IR2. Further, the code reading range CR is set to a range narrower than the imaging range IR1. Accordingly, the payment terminal 100 can narrow the imaging range of the camera 25, reduce a processing load of the second CPU 21, and speed up the reading of the code CD.

Further, the second CPU 21 determines presence or absence of the peeper based on the captured image. In this case, the camera 25 captures an image of a subject around the camera 25. The second CPU 21 determines whether the user H1 using the payment terminal 100 and the third party H2 other than the user are captured in the captured image captured by the camera 25. When the third party H2 is captured, the second CPU 21 estimates a relative positional relation between the user H1 and the third party H2. The second CPU 21 determines whether the third party H2 is the peeper based on the relative positional relation. The relative positional relation may include the distance between the user H1 and the third party H2. For example, the second CPU 21 may detect a person (for example, the user H1 or the third party H2) in the captured image or may detect a face of a person by executing image processing on the captured image. For example, the second CPU 21 may estimate the distance between the user H1 and the third party H2 based on sizes of faces of the user H1 and the third party H2 as described later, or may estimate the distance between the user H1 and the third party H2 based on the number of pixels of regions corresponding to the faces of the user H1 and the third party H2 in the captured image.

The second CPU 21 determines whether the third party H2 is the peeper based on the estimated distance. When the distance is small, there is a high possibility that the third party H2 is the peeper. Therefore, for example, when the estimated distance is equal to or less than a predetermined threshold th1 (predetermined distance), the second CPU 21 determines that the third party H2 is the peeper. For example, when the estimated distance is larger than the predetermined threshold th1 (predetermined distance), the second CPU 21 determines that the third party H2 is not the peeper.

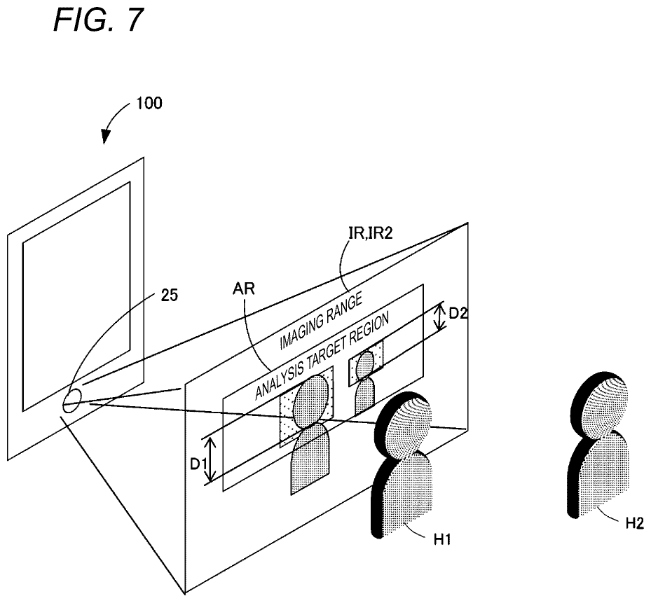

FIG. 7 is a schematic diagram illustrating an example in which, in the peeping detection mode, it is determined whether the third party H2 is the peeper based on a ratio between the size of the face of the user H1 and the size of the face of the third party H2.

The second CPU 21 may estimate the distance by calculating the distance between the user H1 and the third party H2 based on the ratio of the sizes of the faces of both persons. That is, the second CPU 21 extracts contours of the faces of the user H1 and the third party H2, and calculates the ratio between the size of the face of the third party H2 and the size of the face of the user H1. The size of the face of each person is approximately proportional to the distance between the persons. Therefore, the second CPU 21 may calculate (estimate) the distance between the persons based on the ratio of the faces, which is one of differences between the sizes of the faces of the persons.

When the third party H2 is captured in the captured image, the second CPU 21 may estimate a ratio between a size D1 of the face of the user H1 and a size D2 of the face of the third party H2, and determine whether the third party H2 is the peeper based on the ratio. When the ratio of the size D1 of the face of the user H1 to the size D2 of the face of the third party H2 is equal to or less than a predetermined threshold th2, the second CPU 21 determines that the user H1 and the third party H2 are close to each other at a distance equal to or less than the predetermined threshold th1, and that the third party H2 is the peeper. When the ratio of the size D1 of the face of the user H1 to the size D2 of the face of the third party H2 is larger than the predetermined threshold th2, the second CPU 21 determines that the user H1 and the third party H2 are not close to each other at a distance larger than the predetermined threshold th1, and that the third party H2 is not the peeper. It may be possible to directly determine whether the third party H2 is the peeper based on the size D1 of the face of the user H1 and the size D2 of the face of the third party H2 without estimating the distance between the user H1 and the third party H2.

As described above, the payment terminal 100 can easily determine whether the third party H2 is the peeper based on the size D1 of the face of the user H1 and the size D2 of the face of the third party H2.

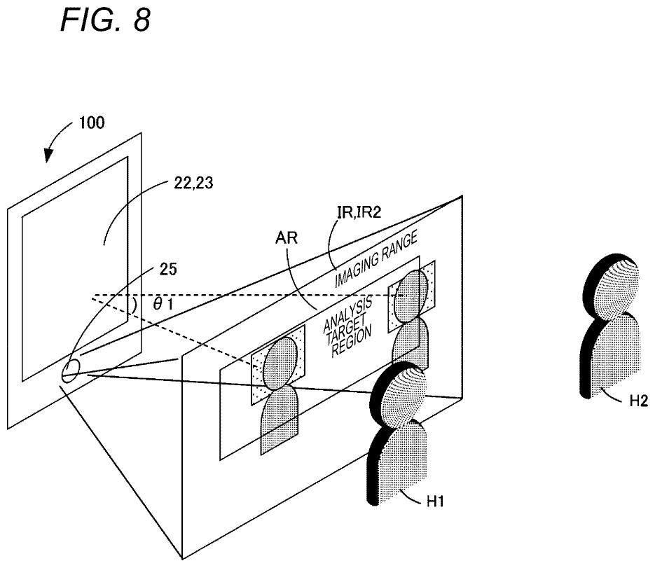

FIG. 8 is a schematic diagram illustrating an example in which, in the peeping detection mode, it is determined whether the third party H2 is the peeper based on an angle formed between the user H1 and the third party H2.

As described above, the second CPU 21 estimates the relative positional relation between the user H1 and the third party H2. The relative positional relation may include an angle θ1 formed between the user H1 and the third party H2 with the display 23 as a base point. That is, the second CPU 21 may estimate the angle θ1 and determine whether the third party H2 is the peeper based on the angle θ1.

For example, when the angle θ1 is small, there is a high possibility that the third party H2 is the peeper who tries to peep from the same direction as the user H1. Therefore, for example, when the estimated angle θ1 is equal to or less than a predetermined threshold th3 (predetermined angle), the second CPU 21 determines that the third party H2 is the peeper. On the other hand, for example, when the estimated angle θ1 is larger than the predetermined threshold th3 (predetermined angle), the second CPU 21 determines that the third party H2 is not the peeper. This is because the positions of the user H1 and the third party H2 with respect to the display 23 are significantly different, and it can be estimated that it is difficult for the third party H2 to peek at the display 23 from a position of the third party H2.

Accordingly, the payment terminal 100 is in a state where the peeping is easy for the third party H2 who approaches from a direction along the display surface of the display 23 and is near the user H1 of the payment terminal 100. The payment terminal 100 can determine such a third party H2 as the peeper.

Through any of the processing processes in FIGS. 6 to 8 described above, the second CPU 21 may determine the third party H2 as the peeper. Further, in order to further improve determination accuracy by the second CPU 21, the second CPU 21 may determine the peeper again by analyzing an orientation of the face, a line of sight, or the like of the third party H2.

Specifically, when it is determined that the third party H2 is the peeper through the processing processes in FIGS. 6 to 8, the second CPU 21 may set an analysis target region AR narrower than the imaging range IR of the camera 25 as illustrated. The analysis target region AR is a region for analyzing information on the third party H2 (for example, the orientation of the face or the line of sight of the third party H2). The analysis target region AR includes the user H1 and one or more third parties H2. The second CPU 21 extracts (cuts out) the analysis target region AR from the imaging range IR. The second CPU 21 analyzes and detects the orientations of the faces or the lines of sight of the user H1 and the third party H2 in the analysis target region AR in detail. Then, the second CPU 21 may determine again and check whether the third party H2 is the peeper based on the analyzed orientation of the face or the line of sight of the third party H2.

Accordingly, the payment terminal 100 can determine presence or absence of peeping based on a direction in which the third party H2 is actually looking, thereby improving the determination accuracy for the peeping.

In addition, the second CPU 21 may continuously determine whether the third party H2 is the peeper through the processing processes in FIGS. 6 to 8 during a period in which a process related to the payment of the user H1 is executed. In this case, the positions of the user H1 and the third party H2 may change over time. In this case, the second CPU 21 may continuously set the analysis target region AR including the user H1 and the third party H2 during the period in which the process related to the payment of the user H1 is executed. Therefore, a position, a size, a range, or the like of the analysis target region AR in the imaging range IR of the camera 25 may be dynamically changed.

The payment terminal 100 can dynamically change the analysis target region AR of the captured image to optimize the analysis target region AR and reduce an analysis load. Therefore, even when the performance of the second CPU 21 is low, the payment terminal 100 can smoothly determine the presence or absence of the peeping using the analysis target region AR. That is, the payment terminal 100 clips the effective pixel used for the analysis within a range of the analysis target region AR to reduce the processing load compared to when the entire imaging range IR is always set as the analysis target region AR.

Next, an example of determining the presence or absence of the peeping using line-of-sight directions of the user H1 and the third party H2 will be described.

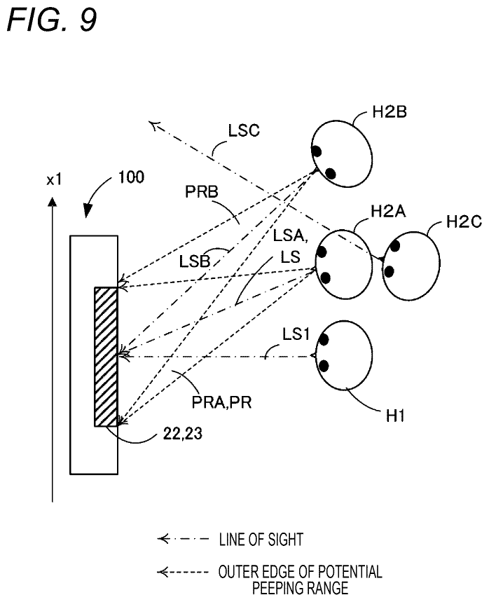

FIG. 9 is a schematic diagram illustrating a relation between the display 23 and each of the line-of-sight directions of the user H1 and the third party H2.

In FIG. 9, the user H1 and the third party H2 (H2A, H2B, and H2C) are viewing the same display 23. The display 23 can display various types of information related to the payment, and can also display the input information (for example, the personal identification number or the electronic signature) used for the payment. FIG. 9 illustrates line-of-sight directions LS of the user H1 and each third party H2. Specifically, a line-of-sight direction LS1 of the user H1, a line-of-sight direction LSA of a third party H2A, a line-of-sight direction LSB of a third party H2B, and a line-of-sight direction LSC of a third party H2C are illustrated. FIG. 9 illustrates a potential peeping range PR of the predetermined third party H2. Specifically, a potential peeping range PRA of the third party H2A and a potential peeping range PRB of the third party H2B are illustrated. The line-of-sight directions LS of the persons are different. When the line-of-sight direction LS of the third party H2 is included in the potential peeping range PR, the third party H2 can check a display content on the display 23. That is, the third party H2 may or may not view the display 23 depending on the line-of-sight direction LS. Since the user H1 uses the touch panel 22 and the display 23 viewed from the front, the line-of-sight direction LS basically coincides with a normal direction to the display surface of the display 23.

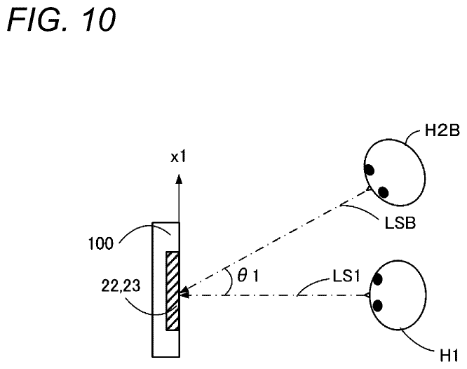

FIG. 10 is a diagram illustrating an example of the angle θ1 formed between the user H1 and the third party H2 with the display 23 as the base point. FIG. 10 illustrates, as an example, the angle θ1 formed between the user H1 and the third party H2B with the display 23 (for example, a center point of the display surface) as the base point.

The angle θ1 may coincide with an angle formed between the line-of-sight direction LS1 of the user H1 and the line-of-sight direction LS (for example, the line-of-sight direction LSB) of the third party H2 with the display 23 as the base point. That is, the angle θ1 may be an angle formed between the line-of-sight direction LS1 of the user H1 and the line-of-sight direction LS (for example, the line-of-sight direction LSB) of the third party H2 with the display 23 as the base point. Since the user H1 is basically located in front of the display 23 as described above, the angle θ1 may coincide with an angle formed between the normal direction to the display surface of the display 23 and the line-of-sight direction LS of the third party H2B.

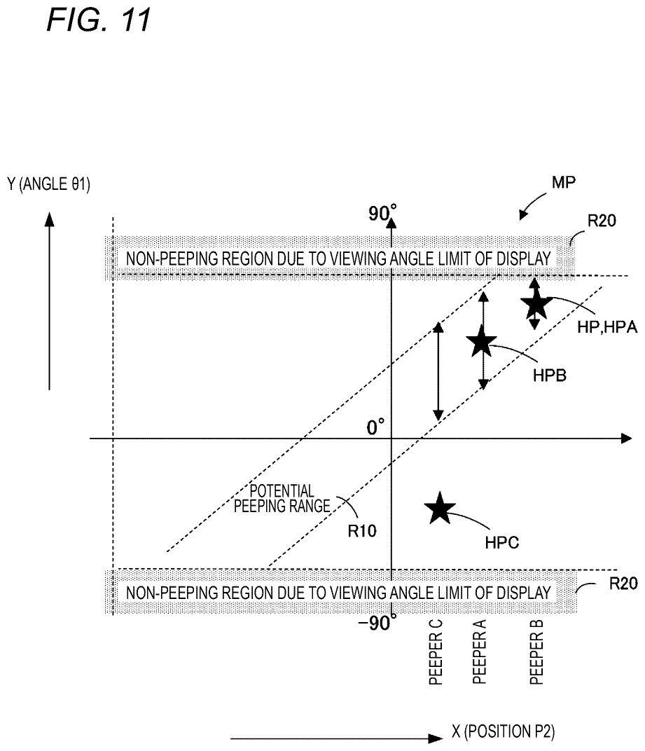

FIG. 11 is a schematic diagram illustrating an example of a map MP indicating a region that can be peeped by the third party on the display 23.

In the map MP, a position P2 is defined on an x-axis. The position P2 is a position of the third party H2 with respect to the user H1 in the direction (x1 direction in FIG. 10) along the display surface of the display 23. In the map MP, the position P2 has a positive value when the third party H3 is located on a right side of the user H1 when viewing the display 23, and the position P2 has a negative value when the third party H3 is located on a left side of the user H1 when viewing the display 23. The angle θ1 is defined on a Y-axis. The angle θ1 is the angle described in FIG. 10.

The second CPU 21 detects, for example, the third party H2 captured in the captured image by image processing. Then, the second CPU 21 detects the position (for example, a position of the face) of the third party H2 and calculates the position P2 and the angle θ1. The angle θ1 is derived using the line-of-sight direction LS, and thus is derived by analyzing the analysis target region AR.

A map position HP, which is a position on the map MP, is determined for each third party H2 by the position P2 and the angle θ1. For example, a map position HPA is uniquely determined by the position P2 and the angle θ1 for the third party H2A. A map position HPB is uniquely determined by the position P2 and the angle θ1 for the third party H2B. A map position HPC is uniquely determined by the location P2 and the angle θ1 for the third party H2C.

In addition, a region R10 in the map MP indicates the potential peeping range PR of the third party H2, that is, a range of the position P2 and the angle θ1 where the peeping is possible. That is, when the map position HP of the third party H2 is present in the region R10, the third party H2 may peep at the display on the display 23, that is, is the peeper. The second CPU 21 determines whether the third party H2 is the peeper based on the position P2 and the angle θ1. Specifically, the second CPU 21 determines that the third party H2 is the peeper when the map position HP of the third party H2 is within the potential peeping range PR, and determines that the third party H2 is not the peeper when the map position HP of the third party H2 is not within the potential peeping range PR. In FIG. 11, the region R10 is a region surrounded by straight lines, but may be a region at least partially surrounded by a curved line.

A region R20 in the map MP is a region (non-peeping region) where the peeping is not possible due to a viewing angle limit of the display 23. A range in which the absolute value of the angle θ1 of the third party H2 is equal to or larger than the predetermined threshold th4 is the non-peeping region. This is because, when an absolute value of the angle θ1 of the third party H2 is equal to or larger than a predetermined threshold th4, the third party H2 views the display 23 substantially from a lateral direction, and thus cannot view the display 23 due to the viewing angle limit. On the other hand, when the absolute value of the angle θ1 of the third party H2 is less than the predetermined threshold th4, that is, when the line-of-sight direction of the third party H2 does not exceed the viewing angle limit, the third party H2 can check the display content on the display 23. Therefore, the second CPU 21 can determine that the third party H2 is the peeper when the map position HP of the third party H2 is within the region R10 and outside the region R20.

In FIG. 11, the line-of-sight direction LS when the display 23 is viewed from the front toward the display 23 is 0°. Further, the line-of-sight direction LS when the display 23 is viewed directly sideways from the right side towards the display 23 (that is, the x1 direction in FIG. 10) is 90°. Further, the line-of-sight direction LS when the display 23 is viewed directly sideways from the left side towards the display 23 (that is, a direction opposite to the x1 direction in FIG. 10) is −90°. Although FIG. 11 illustrates that the angle θ1 is derived based on the line-of-sight direction LS, the angle θ1 may be derived based on the orientation of the face instead of the line-of-sight direction.

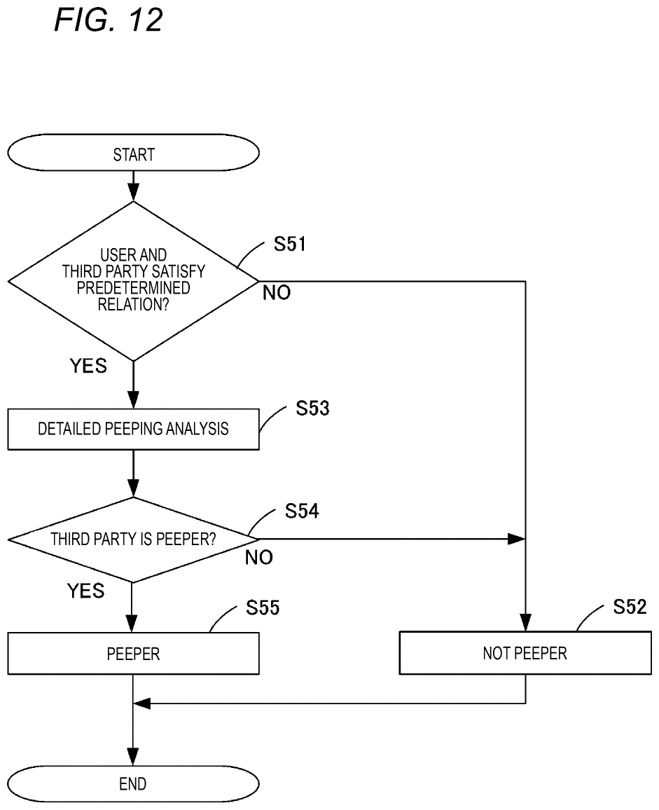

FIG. 12 is a flowchart illustrating an operation example of the payment terminal 100 that determines whether the third party H2 captured in the captured image is the peeper in step S5 in FIG. 3. Here, as illustrated in FIGS. 6 to 8, it is assumed that the third party H2 other than the user H1 is captured in the captured image.

First, the second CPU 21 executes a peeping determination based on a threshold (step S51). That is, the second CPU 21 determines whether a positional relation between the user H1 and the third party H2 captured in the captured image satisfies a predetermined relative positional relation. The relative positional relationship here is the following relation for examples of FIGS. 6 to 8. Specifically, in the case of FIG. 6, the distance between the user H1 and the third party H2 is equal to or less than the predetermined threshold th1. In the case of FIG. 7, the ratio of the size D1 of the face of the user H1 to the size D2 of the face of the third party H2 is equal to or less than the predetermined threshold th2. In the case of FIG. 8, the angle formed between the user H1 and the third party H2 is equal to or less than the predetermined threshold th3.

There is a high possibility that the third party H2 is the peeper when the above-described relative positional relation is satisfied, and there is a low possibility that the third party H2 is the peeper when the above-described relation is not satisfied. Therefore, when the above-described relative positional relation is not satisfied (step S51, No), the second CPU 21 determines that the third party H3 is not the peeper (step S52).

When the above-described relative positional relation is satisfied (step S51, Yes), the second CPU 21 executes a detailed peeping analysis based on the orientation of the face, the line of sight, or the like of the third party H2 in order to further improve the determination accuracy for the peeping (step S53). In the detailed peeping analysis, the second CPU 21 may cut out (crop) the analysis target region AR illustrated in FIGS. 6 to 8 from the imaging range IR, reduce the analysis load, and then detect the face of the third party H2, and detect the orientation of the face, the line of sight, or the like of the third party H2.

The second CPU 21 determines again whether the third party H2 is the peeper based on the orientation of the face, the line of sight, or the like of the third party H2 (step S54). For example, the second CPU 21 derives (for example, calculates) the above-described position P2 and angle θ1, and derives (for example, calculates) the map position HP of the third party H2 on the map MP illustrated in FIG. 11. When the map position HP of the third party H2 is located in the region R10, the second CPU 21 determines that the third party H2 is the peeper (step S55). On the other hand, when the map position HP of the third party H2 is not located in the region R10, the second CPU 21 determines that the third party H2 is not the peeper (step S52). The second CPU 21 proceeds from step S55 to step S6A in FIG. 3, and proceeds from step S52 to step S6B in FIG. 3.

Step S6A in FIG. 3 is activation of the anti-peeping mode when it is determined that the third party H2 is the peeper (including re-determination). When it is finally determined that the third party H2 is the peeper, the second CPU 21 activates the anti-peeping mode for changing settings of the display 23, the touch panel 22, or the like. Accordingly, peeping by the third party H2 can be prevented.

In FIG. 12, the process of step S54 may be omitted. In this case, the peeping determination executed by the second CPU 21 is executed in the process of step S51, and a final determination result is obtained.

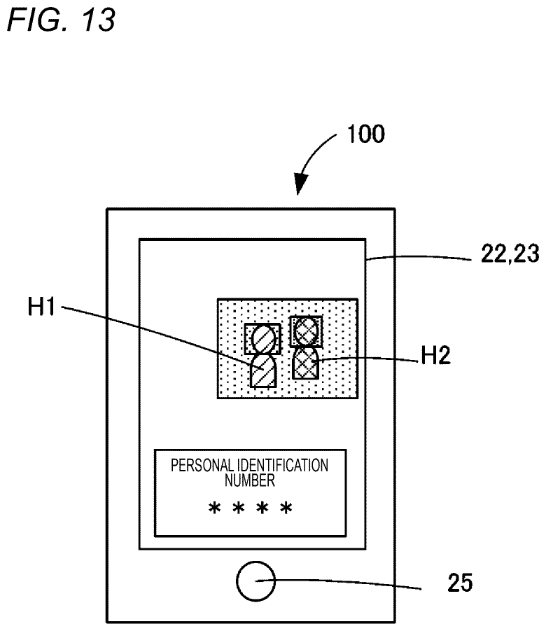

FIG. 13 is a schematic diagram illustrating a display example in which the user H1 and the third party H2 are displayed in different display modes on the display 23, which is one aspect of the anti-peeping mode. The second CPU 21 causes the display 23 to display the user H1 and the third party H2 in the different display modes. The different display modes include, for example, color-coded display for the user H1 and the third party H2, a display in which only the third party H2 is surrounded by a frame, and the like. Accordingly, the user H1 can more reliably recognize the presence of the peeper by checking the display in the display mode.

In one aspect of the anti-peeping mode, the second CPU 21 may set the viewing angle of the display 23 to be narrower than that before it is determined that the third party H2 is the peeper. Accordingly, the payment terminal 100 can make it difficult for the peeper to peep when the peeper is present.

In one aspect of the anti-peeping mode, the second CPU 21 may cause the display 23 to display information indicating that the peeper is present. Such information may be, for example, a message notifying the presence of the peeper, a pop-up display for calling attention that the peeper is present, or the like. The message or the pop-up display may include warning information such as “there is a possibility of peeping”. Accordingly, the payment terminal 100 can allow the user H1 to recognize the presence of the peeper by checking the display regarding the peeper.

In addition, in one aspect of the anti-peeping mode, the second CPU 21 may stop receiving the input information via the touch panel 22. Accordingly, the payment terminal 100 can prevent the input information such as the personal identification number from being input when the peeper is present.

In addition, in one aspect of the anti-peeping mode, the second CPU 21 may cause the display 23 to display a cancel button that is a button for which an input operation can be executed via the touch panel 22 and that stops the payment process. In this case, the second CPU 21 positions the cancel button within a visible viewing angle range even when the viewing angle of the display 23 is narrowed. In addition, after the above-described pop-up display for calling attention, the second CPU 21 may display the cancel button while avoiding a position of the pop-up display. Accordingly, when the peeper is present, the payment terminal 100 may stop the payment process according to an intention of the user H1.

FIGS. 14A, 14B, and 14C are each a sequence diagram illustrating transmission and reception of information between members of the payment terminal 100. FIG. 14A mainly illustrates a process from the start of payment to a personal identification number input operation. FIG. 14B mainly illustrates various processes in a peeping-related process. FIG. 14C mainly illustrates a process from a peeping notification or the personal identification number input operation to payment completion.

As illustrated in FIG. 14A, the user H1 operates the touch panel 22 to start the payment (S101). The process in step S101 includes selecting a payment method (for example, the first payment method), and corresponds to step S1 in FIG. 3. When the touch panel 22 accepts an operation for starting the payment (payment start operation), payment start operation information is transmitted to the second CPU 21 (S102).

Upon receiving the payment start operation information, the second CPU 21 transmits a payment start instruction to the first CPU 11 (S201). The payment start instruction here is, as an example, payment according to the first payment method that requires the input of the personal identification number (Yes in step S2 in FIG. 3).

Upon receiving the payment start instruction, the first CPU 11 generates an activation signal of the first card reader 16 or the second card reader 17 (hereinafter, also simply referred to as a “card reader”) (S301), and transmits the activation signal to the card reader (S302). The card reader reads data of a card (for example, the magnetic card or the contact IC card) of the user H1 (S401), and transmits read information to the first CPU 11 (S402). Upon receiving the read information, the first CPU 11 generates a communication completion presentation instruction indicating that communication with the card reader has been completed (S303), and transmits communication completion information to the second CPU 21 (S304).

Further, the first CPU 11 generates a touch panel control switching signal for switching a control source of the touch panel 22 from the second CPU 21 to the first CPU 11 (S305), and transmits the touch panel control switching signal including a touch panel switching instruction to the switch 29 (S306). Further, the first CPU 11 transmits, to the touch panel 22, a personal identification number input instruction for prompting the user H1 to input the personal identification number (S307), the touch panel 22 displays information for accepting the input of the personal identification number, and waits for the input operation of the personal identification number executed by the user H1 (S103).

On the other hand, in parallel with the above-described processes in steps S301 to S103, the second CPU 21 transmits the above-described payment start instruction (S201), then generates a camera activation signal for activating the camera 25 (S202), and transmits the camera activation signal to the camera 25 (S203). Upon receiving the camera activation signal, the camera 25 is activated, starts capturing an image of the subject around the camera 25 (S501), and transmits the captured image to the second CPU 21 (S502).

Upon receiving the captured image, the second CPU 21 activates the peeping detection mode (S503). Step S503 corresponds to step S4 in FIG. 3. After step S503, the second CPU 21 executes the peeping-related process related to the peeping (see FIG. 14B).

As illustrated in FIG. 14B, the second CPU 21 branches depending on conditions in the peeping-related process. When there is no person other than the user H1 captured in the captured image or when a predetermined relation (predetermined relative positional relation) is not satisfied between the user H1 and the captured third party H2 (for example, No in step S5 in FIG. 3 and No in step S51 in FIG. 12), the second CPU 21 instructs the display 23 to continue a normal display mode (S204). Step S204 corresponds to transmission of display data in the normal display mode from the second CPU 21 to the display 23, and corresponds to step S6B in FIG. 3. In the normal display mode, for example, the display at a narrow viewing angle as in the anti-peeping mode is not executed, and normal display is executed.

On the other hand, when there is the third party H2 other than the user H1 captured in the captured image and the predetermined relation is satisfied between the user H1 and the captured third party H2 (Yes in step S51 of FIG. 12), the second CPU 21 executes the detailed peeping analysis (S205). In the detailed peeping analysis, when the second CPU 21 determines that the third party H2 is not the peeper based on the orientation of the face, the line of sight, or the like of the third party H2 (S206), the second CPU 21 instructs the display 23 to continue the normal display mode (S207). Step S206 corresponds to No in step S54 in FIG. 12.

In the detailed peeping analysis, when the second CPU 21 determines that the third party H2 is the peeper based on the orientation of the face, the line of sight, or the like of the third party H2 (Yes in step S54 in FIG. 12), the second CPU 21 activates the anti-peeping mode (S208). Step S208 corresponds to step S6A in FIG. 3. The second CPU 21 transmits, for example, display data in the anti-peeping mode or a control signal in the anti-peeping mode to the display 23 (S209). Such display data and control signal include, for example, narrowing the viewing angle of the display 23 and a message for alerting the presence of the peeper.

Further, when it is determined that the third party is the peeper, the second CPU 21 transmits, to the first CPU 11, a peeping notification indicating that the peeping is present (S210).

As illustrated in FIG. 14C, upon receiving the peeping notification, the first CPU 11 interrupts the input of the personal identification number (S308). In this case, for example, the first CPU 11 interrupts (stops) the reception of the input information of the personal identification number executed via the touch panel 22. However, when the peeping stops, the first CPU 11 may resume the process.

After step S103, when the touch panel 22 receives the input of the personal identification number, the touch panel 22 notifies the first CPU 11 of completion of the input of the personal identification number (S104), and the first CPU 11 checks the personal identification number (S309). Then, the first CPU 11 generates a touch panel control switching signal for switching the control of the touch panel 22 from the first CPU 11 to the second CPU 21 (S310), and transmits the touch panel control switching signal including a touch panel switching instruction to the switch 29 (S311). Further, the first CPU 11 transmits the input information of the personal identification number to the second CPU 21 (S312). Upon receiving the input information of the personal identification number, the first CPU 11 ends the peeping detection mode (S211). Step S211 corresponds to step S8 in FIG. 3.

The second CPU 21 generates a camera stop signal for stopping the operation of the camera 25 (step S212), and transmits the camera stop signal to the camera 25 (step S213). Upon receiving the camera stop signal, the camera 25 stops the operation such as imaging.

The first CPU 11 and the second CPU 21 execute the payment process using the acquired input information of the personal identification number (step S601). When the payment process is completed, the first CPU 11 transmits a payment completion notification to the second CPU 21 (step S313). Upon receiving the payment completion notification, the second CPU 21 transmits, to the display 23, a payment completion display signal including an instruction to display payment completion (step S214). Upon receiving the payment completion display signal, the display 23 displays information indicating that the payment is completed.

According to the payment terminal 100 according to the present embodiment, the presence or absence of the peeping is determined according to a circumstance around the user H1 based on the captured image captured by the camera 25, specifically, based on the relative positional relation between the user H1 and the third party H2. Since the anti-peeping mode is automatically activated when the peeping is present, for example, it is not necessary for the user H1 or the store clerk to set a blind function each time. In addition, since the payment terminal 100 can use the camera 25 for the code payment as well as for the peeping detection, the miniaturization of the payment terminal 100 can be implemented. In addition, the payment terminal 100 can improve the security of the user H1 by controlling the viewing angle or visibility or executing the pop-up display for calling attention.

Further, the payment terminal 100 can improve a monitoring function for the surroundings of the user H1 by widening the imaging range of the camera 25 at the time of inputting the personal identification number. The payment terminal 100 can provide the monitoring function even when the performance of the second CPU 21 is low by dynamically changing the analysis target region AR within the imaging range IR to optimize the analysis target region AR and reduce the analysis load.

### Modification

In the present embodiment, the payment terminal 100 including one touch panel 22 and one display 23 is mainly exemplified, but the present disclosure is not limited thereto. For example, the payment terminal 100 may be a payment terminal 100A in which a customer-side portion and a store clerk-side portion are separately used, and one touch panel and one display are provided in each portion. In other words, in the payment terminal 100A, a payment block that executes a process related to payment and an application block that executes a process related to an image each include the display and the touch panel. The first CPU 11 and the second CPU 21 are communicably connected to each other.

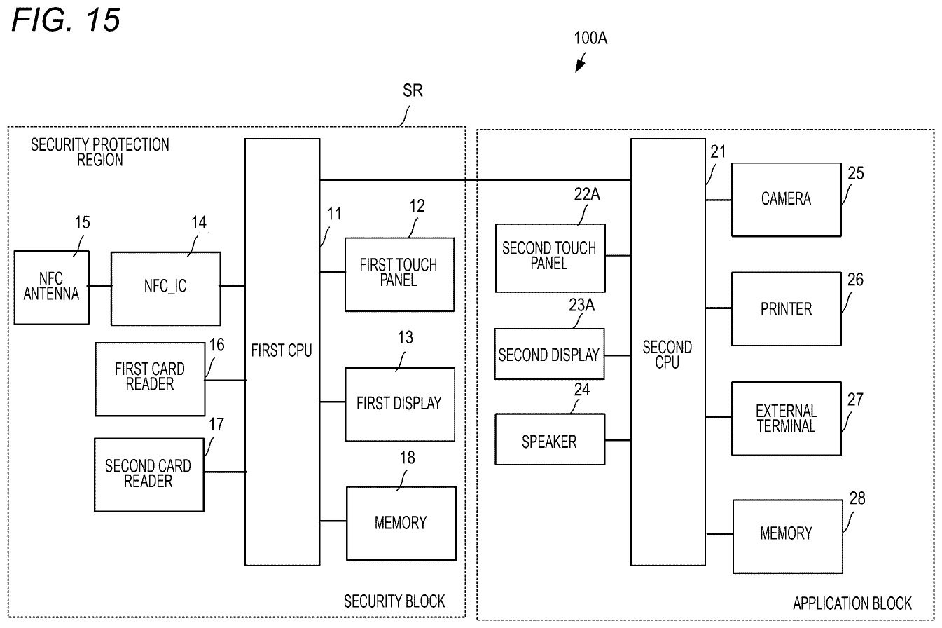

FIG. 15 is a block diagram illustrating a first modification (payment terminal 100A) of an electrical configuration of the payment terminal 100. The payment block of the payment terminal 100A includes the first CPU 11, a first touch panel 12, a first display 13, the NFC_IC 14, the NFC antenna 15, the first card reader 16, the second card reader 17, and the memory 18. The application block of the payment terminal 100A includes the second CPU 21, a second touch panel 22A, a second display 23A, a speaker 24, the camera 25, a printer 26, the external terminal 27, and the memory 28.

Further, the payment terminal 100 may be a payment terminal 100B that executes the process related to the payment, and an application terminal 300 that executes the process related to the image or the like may be provided separately from the payment terminal 100. The payment terminal 100B and the application terminal 300 may be communicably connected via respective communication units (not illustrated) to form a payment system 500. In other words, the payment terminal 100B includes a payment block, the application terminal 300 includes an application block, and the payment terminal 100B and the application terminal 300 each include a display and a touch panel.

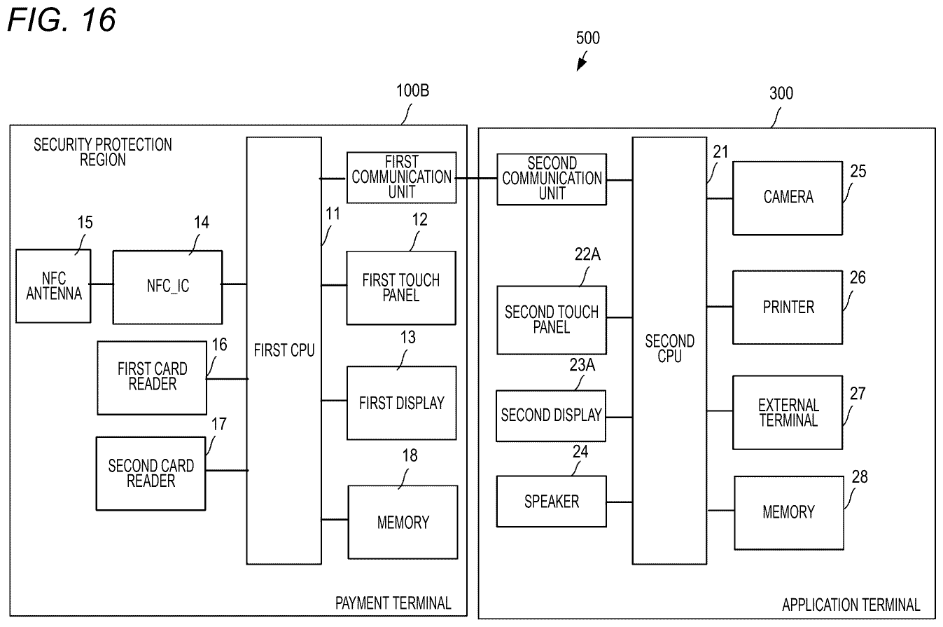

FIG. 16 is a block diagram illustrating a second modification (payment terminal 100B) of the electrical configuration of the payment terminal 100. The payment terminal 100B includes the first CPU 11, the first touch panel 12, the first display 13, the NFC_IC 14, the NFC antenna 15, the first card reader 16, the second card reader 17, and the memory 18. The application terminal 300 includes the second CPU 21, the second touch panel 22A, the second display 23A, the speaker 24, the camera 25, the printer 26, the external terminal 27, and the memory 28. The camera 25 is externally disposed on the payment terminal 100B, but is electrically connected to the second CPU 21.

As described above, at least the following matters are described in the present disclosure. Components corresponding to those in the above-described embodiment are shown in parentheses, but the present disclosure is not limited thereto.

### (Item 1)

A payment terminal (payment terminal 100) capable of executing payment using a code (code CD), including:
a camera (camera 25) configured to capture an image of a subject; and
a processor (second CPU 21) configured to process a captured image captured by the camera, in which
the processor
   determines whether a first person (user H1) using the payment terminal and a second person (third party H2) other than the first person are captured in the captured image,
   estimates a relative positional relation between the first person and the second person when the second person is captured, and
   determines whether the second person is a peeper based on the relative positional relation.

Accordingly, since the payment terminal can use the camera for the code payment as well as for the peeping detection, the security can be maintained while implementing the miniaturization of the payment terminal.

### (Item 2)

The payment terminal according to item 1, in which
the processor
   is capable of executing the payment according to a plurality of payment methods, and
   when a first payment method is designated in which the payment is executed using input information (a personal identification number or an electronic signature) that is to be input to a touch panel (touch panel 22) and is used for authenticating the payment, widens an imaging range (imaging range IR) of the camera compared to when a second payment method is designated in which the payment is executed without using the input information.

Accordingly, since the payment terminal widens the imaging range of the camera when the payment method requiring the input information is designated, the peeper who may be present around the user of the payment terminal is likely to be captured. Therefore, the peeper is easily detected.

### (Item 3)

The payment terminal according to item 2, in which
the processor sets the imaging range of the camera to an imaging range of a maximum angle of view of the camera when the first payment method is designated.

Accordingly, since the payment terminal maximizes the imaging range of the camera, the peeper who may be present around the user of the payment terminal can be captured to a maximum extent.

### (Item 4)

The payment terminal according to any one of items 1 to 3, in which
the processor
   sets a region, which is narrower than the imaging range of the camera and includes the first person and the second person, as an analysis target region (analysis target region AR) when it is determined that the second person is the peeper,
   analyzes an orientation of a face or a line of sight of the second person, and
   determines again whether the second person is the peeper based on the analyzed orientation of the face or the line of sight of the second person.

Accordingly, the payment terminal can determine presence or absence of peeping based on a direction in which the second person is actually looking, thereby improving the determination accuracy for the peeping. In addition, by setting the analysis target region to be narrower than the imaging range so as to include the person (for example, the face of the person), the payment terminal can reduce the processing load compared to a case where the entire imaging range is analyzed, and can speed up determination of the peeping.

### (Item 5)

The payment terminal according to any one of items 2 to 4, in which
the second payment method is payment using the code, and
when the second payment method is designated, the processor sets a code reading range for reading the code that is narrower than the imaging range, and reads the code in the code reading range.

Accordingly, the payment terminal narrows the imaging range of the camera, which reduces the processing load of the processor and speeds up the reading of the code.

### (Item 6)

The payment terminal according to any one of items 1 to 5, in which
the relative positional relation includes a distance between the first person and the second person.

For example, when the first person and the second person are close to each other, the input information input by the first person may be peeped from a short distance. Therefore, the payment terminal can determine whether the second person is the peeper with high accuracy by considering the distance between the first person and the second person as the relative positional relation.

### (Item 7)

The payment terminal according to item 6, in which
the processor
   calculates a ratio between a size of a face of the first person and a size of a face of the second person when the second person is captured, and
   estimates the distance based on the ratio.

The size of the face of each of a plurality of persons captured in the captured image is proportional to a distance of the face of the person to the camera. Therefore, the payment terminal can estimate the distance between the persons with high accuracy by considering the ratio between the sizes of the face of the persons.

### (Item 8)

The payment terminal according to any one of items 1 to 7, in which
the relative positional relation includes an angle formed between the first person and the second person with the camera as a base point.

For example, when the angle formed between the first person and the second person is small, the first person and the second person are present at the same angle with respect to the display 23, and therefore, the input information input by the first person may be peeped from a short distance. Therefore, the payment terminal can determine whether the second person is the peeper with high accuracy by considering the distance between the first person and the second person as the relative positional relation.

### (Item 9)

The payment terminal according to any one of items 1 to 8, in which
when it is determined that the second person is the peeper, the processor sets a viewing angle of a display device (display 23) to be narrower than that before it is determined that the second person is the peeper.

Accordingly, the payment terminal can execute an adjustment to make it difficult for the peeper to peep when the peeper is present.

### (Item 10)

The payment terminal according to any one of items 1 to 9, in which
when it is determined that the second person is the peeper, the processor causes a display device to display information indicating that the peeper is present.

Accordingly, the payment terminal can cause the user to recognize that the peeper is present.

### (Item 11)

The payment terminal according to any one of items 1 to 10, in which
when it is determined that the second person is the peeper, the processor causes a display device to display the first person and the second person in different display modes.

Accordingly, the payment terminal can cause the user to more reliably recognize the presence of the peeper.

### (Item 12)

The payment terminal according to any one of items 1 to 11, in which
the processor stops receiving the input information via the touch panel when it is determined that the second person is the peeper.

Accordingly, the payment terminal can prevent the input information such as the personal identification number that may be peeped from being input, can prevent the input information from being actually used for processing after the input, and can ensure the security.

### (Item 13)

A payment assistance method executed by a payment terminal capable of executing payment using a code, the payment assistance method including:
a step of acquiring a captured image captured by a camera configured to capture an image of the code used for the payment, and capture an image of a subject, the camera being provided in the payment terminal;
a step of determining whether a first person using the payment terminal and a second person other than the first person are captured in the captured image;
a step of estimating a relative positional relation between the first person and the second person when the second person is captured; and
a step of determining whether the second person is a peeper based on the relative positional relation.

Accordingly, since the payment terminal that implements the payment assistance method can use the camera for the code payment as well as for the peeping detection, the security can be maintained while implementing the miniaturization of the payment terminal.

Although various embodiments are described above with reference to the drawings, it is needless to say that the present disclosure is not limited to such examples. It is apparent that a person skilled in the art can conceive of various modifications and alterations within the scope described in the claims, and it is understood that such modifications and alterations naturally fall within the technical scope of the present disclosure. In addition, the constituent elements in the above embodiments may be freely combined without departing from the scope of the invention.

In the above-described embodiment, the program for implementing the function of the payment assistance method may be supplied to the electronic apparatus (for example, the payment terminal) which is a computer via a network or various storage media, and a program that is read and executed by the processor of this electronic apparatus and a recording medium in which this program is stored may be used as the application range.

The present disclosure is based on Japanese Patent Application No. 2023-092730 filed on Jun. 5, 2023, and the contents thereof are incorporated herein by reference.

### Industrial Applicability

The present disclosure is useful for a payment terminal, a payment assistance method, and the like that can improve security while maintaining miniaturization of the payment terminal.

What is claimed is:

1. A payment terminal including a first region serving as a security protection region and a second region outside the security protection region within a device body, and capable of executing a payment process by a plurality of payment methods, the payment terminal comprising:
a first processor that is disposed in the first region and executes a process of a first payment method requiring an input of a personal identification number;
a camera that is disposed in the second region and captures an image of a subject;
a second processor that is disposed in the second region, is connected to the first processor, and processes a captured image captured by the camera; and
a touch panel that displays an input screen of the personal identification number, wherein
in a case that the first payment method is designated among the plurality of payment methods, the first processor executes the payment process requiring the input of the personal identification number, displays the input screen of the personal identification number on the touch panel, and stops receiving the input of the personal identification number upon receiving a peeping notification indicating that peeping is executed for the input of the personal identification number,
in a case that a second payment method in which payment is executed using the code is designated among the plurality of payment methods, the second processor executes the payment process using a code captured by the camera, and
in a case that the first payment method is designated among the plurality of payment methods, the second processor determines whether a first person using the payment terminal and a second person other than the first person are captured in the captured image, estimates a relative positional relation between the first person and the second person when the second person is captured, determines whether the second person is a peeper based on the relative positional relation, and executes the peeping notification to the first processor when it is determined that the second person is the peeper.

2. The payment terminal according to claim 1, wherein
in a case that the first payment method is designated, the second processor widens an imaging range of the camera compared to when the second payment method is designated.

3. The payment terminal according to claim 2, wherein
in a case that the first payment method is designated, the second processor sets the imaging range of the camera to an imaging range of a maximum angle of view of the camera.

4. The payment terminal according to claim 1, wherein
the second processor
sets a region, which is narrower than the imaging range of the camera and includes the first person and the second person, as an analysis target region when it is determined that the second person is the peeper,
analyzes an orientation of a face or a line of sight of the second person with respect to the analysis target region, and
determines again whether the second person is the peeper based on the analyzed orientation of the face or the line of sight of the second person.

5. The payment terminal according to claim 1, wherein
the relative positional relation includes a distance between the first person and the second person.

6. The payment terminal according to claim 5, wherein
the second processor
calculates a ratio between a size of a face of the first person and a size of a face of the second person when the second person is captured, and
estimates the distance based on the ratio.

7. The payment terminal according to claim 1, wherein
the relative positional relation includes an angle formed between the first person and the second person with the camera as a base point.

8. The payment terminal according to claim 1, wherein
in a case that it is determined that the second person is the peeper, the second processor sets a viewing angle of a display device to be narrower than that before it is determined that the second person is the peeper.

9. The payment terminal according to claim 1, wherein
in a case that it is determined that the second person is the peeper, the second processor causes a display device to display information indicating that the peeper is present.

10. The payment terminal according to claim 1, wherein
in a case that it is determined that the second person is the peeper, the second processor causes a display device to display the first person and the second person in different display modes.

11. A payment assistance method executed by a payment terminal that includes a first processor located in a security protection region in a device body and a second processor located outside the security protection region in the device body and is capable of executing a payment process by a plurality of payment methods, the payment assistance method comprising:
in a case that a first payment method is designated among the plurality of payment methods,
executing, by the first processor, the payment process requiring an input of a personal identification number and displaying an input screen of the personal identification number,
acquiring, by the first processor, a captured image captured by a camera located outside the security protection region,
determining, by the first processor, whether a first person using the payment terminal and a second person other than the first person are captured in the captured image,
estimating, by the first processor, a relative positional relation between the first person and the second person when the second person is captured,
determining, by the first processor, whether the second person is a peeper based on the relative positional relation,
executing, by the second processor, a peeping notification to the first processor in a case that it is determined that the second person is the peeper, and
stopping, by the first processor, receiving the input of the personal identification number upon receiving the peeping notification; and
in a case that the second payment method is designated among the plurality of payment methods,
executing, by the second processor, a code payment process using a code captured by the camera.

12. The payment assistance method according to claim 11, wherein
in a case that it is determined that the second person is the peeper, information indicating that the peeper is present is displayed on a display device of the payment terminal.

13. The payment assistance method according to claim 11, wherein
in a case that it is determined that the second person is the peeper, the first person and the second person are displayed in different display modes on a display device of the payment terminal.
